(19) United States
(12) Patent Application Publication
(10) Pub. No.: US 2012/0098270 A1
(43) Pub. Date: Apr. 26, 2012

(54) External Rotor Generator of Vertical Axis Wind Turbine

(75) Inventors: Hanjun Song, Beijing (CN); Yun Liu, New York, NY (US); Nicolas Blitterswyk, New York, NY (US)

(73) Assignee: URBAN GREEN ENERGY, INC., New York, NY (US)

(21) Appl. No.: 13/380,733

(22) PCT Filed: Jun. 24, 2010
(86) PCT No.: PCT/IB2010/001523

§ 371 Date: Dec. 23, 2011

(30) Foreign Application Priority Data
Jun. 26, 2009 (CN) 200920160536.4

(51) Int. Cl. F03D 9/00; F03D 3/06

(52) U.S. Cl. 290/55

(57) ABSTRACT

A vertical axis wind turbine characterized in an external rotor generator comprising an external rotor generator and wind turbine arranged on the external rotor generator.

### TECHNICAL FIELD

The present invention relates to an external rotor generator for a vertical axis wind turbine.

### BACKGROUND ART

At present, a wind rotor is usually arranged on an external rotor i.e. a generator enclosure for an external rotor generator of a vertical axis wind turbine. This may increase the friction resistance of the generator rotor by applying the weight of the wind rotor on the main generator shaft, so as to increase the start up speed of the wind rotor. The required power of the wind turbine cannot be achieved without enlarging the dimension of the wind rotor. It is well known that the longer the wind rotor shaft of a vertical axis wind turbine, the more difficult the delivery, erection, windings installation and assembly of the generator.

DE19516504 discloses a wind-driven generator comprising a vertical turbine rotor system positioned perpendicular to the wind direction, with an external rotor and an internal rotor which rotate in opposite directions about a common rotation axis. Preferably the external rotor has a number of radial carrier elements with tangential curved blades at the rotor periphery, the inner rotor provided by a lesser number of curved rotor blades, with both rotors driving a common generator.

CN101532471 discloses a magnetic suspension vertical turbine wind generator. A wind guiding passage of a turbine and an axis line parallel to the wind direction form an included angle of 35° to 40°; an axial bearing structure consists of a main bearing part consisting of a magnetic bearing and an auxiliary bearing part consisting of mechanical rollers; the mechanical rollers are distributed symmetrically and circularly arranged on an object stage of a tower base; the magnetic bearing comprises active suction type electromagnet coils which are vertically arranged above and below a main working shaft cam to correspondingly form a working unit, all working units are equally distributed in circular symmetry and arranged outside the mechanical rollers in concentric circles with mechanical roller bearings, and each electromagnet unit ensures that magnetic poles are opposite; and the turbine is in a form of vertical turbine structure. The wind generator has a reasonable structure, can obtain higher generating efficiency under the condition of low wind speed, and has the advantages of low starting wind speed, high wind energy utilization efficiency, simple structure and convenient maintenance.

### DEFINITIONS

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

### SUMMARY OF THE INVENTION

Provided herein is an external rotor generator for a vertical axis wind turbine with the advantages of a simple structure and decreased start up wind speed of the wind rotor.

The external rotor generator of the present invention is designed to transfer weight to the tower, via the bearings of the wind rotor shaft and the wind rotor shaft. This reduces stress on the bearing(s) of the generator. The multiple bearings system and the inner and outer axis formation even out loads and reduce pressure on the generator directly from the wind rotor and through the sideways wind force.

The external rotor generator of the vertical axis wind turbine, comprising the external rotor generator and the wind turbine arranged on the external rotor generator, wherein, the mentioned external rotor generator consists of the generator shaft, stator and external rotor arranged on the external stator, wherein, the mentioned generator shaft may be a hollow or solid shaft. Preferably the mentioned generator shaft is a hollow shaft. The mentioned stator may be arranged externally to the mentioned generator shaft, with the shaft keeping locational fit with the generator shaft.

The mentioned wind turbine consists of the wind rotor shaft and the wind rotor, and the mentioned wind rotor shaft is arranged on the internal of the mentioned generator shaft, keeping locational fit with the generator shaft. The upper flange and lower flange of the wind rotor may be arranged at both ends of the mentioned wind rotor shaft upper and lower via the bearing.

Alternatively, the upper flange and lower flange of the wind rotor may be arranged at any position along the mentioned wind rotor shaft via the bearing. There may be any number of upper flange(s) and/or lower flange(s) of the wind rotor which may be arranged at any position along the mentioned wind rotor shaft either via the bearing or not via the bearing.

The mentioned wind rotor may be arranged on the upper flange and the lower flange of the wind rotor. The lower flange of the mentioned wind rotor may be positioned on the upward side of the external rotor generator, and connect with the external rotor of the external rotor generator.

The mentioned wind rotor may be arranged on the upper flange and the lower flange of the wind rotor. The lower flange of the mentioned wind rotor may be positioned above the upward side of the external rotor generator, and connect with the external rotor of the external rotor generator.

The drive shaft barrel of the wind rotor may be arranged between the mentioned upper flange and lower flange of the wind rotor, and the mentioned drive shaft barrel sleeve of the wind rotor may be arranged on the external of the wind rotor shaft.

Alternatively, the drive shaft barrel of the wind rotor may be arranged between the mentioned upper flange and lower flange of the wind rotor and extend beyond the mentioned upper flange and lower flange of the wind rotor, and the mentioned drive shaft barrel sleeve of the wind rotor may be arranged on the external of the wind rotor shaft.

The mentioned wind rotor shaft may be arranged on the internal of the mentioned generator shaft and extended through the generator and attached to a tower below said generator. Alternatively, the mentioned wind rotor shaft may be arranged on the internal of the mentioned generator shaft and extended through the generator located at the upper end of the wind rotor shaft and attached to a tower above said generator. In a further alternative embodiment of the present invention, the mentioned wind rotor shaft may be arranged on the internal of the mentioned generator shaft and extended through the generator and attach to a tower below said generator and attach to a tower above said wind rotor shaft. In a further alternative, the mentioned wind rotor shaft may be arranged on the internal of the mentioned generator shaft and extended through the generator and attach to a platform below said generator and attach to a tower or platform above said wind rotor shaft.

Fixtures for attachment means that may be used include and are not limited to bolts, screws, nails and nuts.

Adopting the above-mentioned structure, the shaft of the wind turbine may be designed as two shafts, i.e. the wind rotor shaft and the generator shaft. The wind rotor shaft may be a hollow shaft, which may be inserted into the bottom of the generator shaft and be locked. The wind rotor shaft may extend the length of the wind turbine. Pressure is applied to the inner axis from the top to the bottom, with a substantially equal distribution through two or more bearings. The upper, lower and/or midsection connecting arms of the wind rotor may be connected via the flange of the wind rotor shaft through the bearing respectively, and be united together by the drive shaft barrel of the wind rotor. Meanwhile, the wind rotor may be connected with the external rotor of the external rotor generator. Thus, the weight and sideways wind force can be transferred to the tower via the wind rotor shaft bearing(s) and wind rotor shaft therefore preventing the bearing(s) of the generator being stressed due to the wind rotor applying pressure on the generator directly, so as to decrease the start up wind speed of the wind rotor.

Further advantages of the above-mentioned structure are the maintenance of a low rpm, increased torque, reduced vibrations and reduced noise, thus improved safety of the wind turbine.

### BRIEF DESCRIPTION OF DRAWINGS

Hereunder the present invention may be given further description with incorporation of the attached figures.

FIG. 1 is a schematic illustration, longitudinal sectional view, of the present invention.

FIG. 2 is a schematic illustration, longitudinal sectional view, of the outline of the present invention.

FIG. 3 is a schematic illustration, longitudinal sectional perspective view, of the present invention.

FIG. 4 is a schematic illustration, longitudinal sectional view, of the generator shaft.

### DETAILED DESCRIPTION OF SPECIFIC EMBODIMENTS

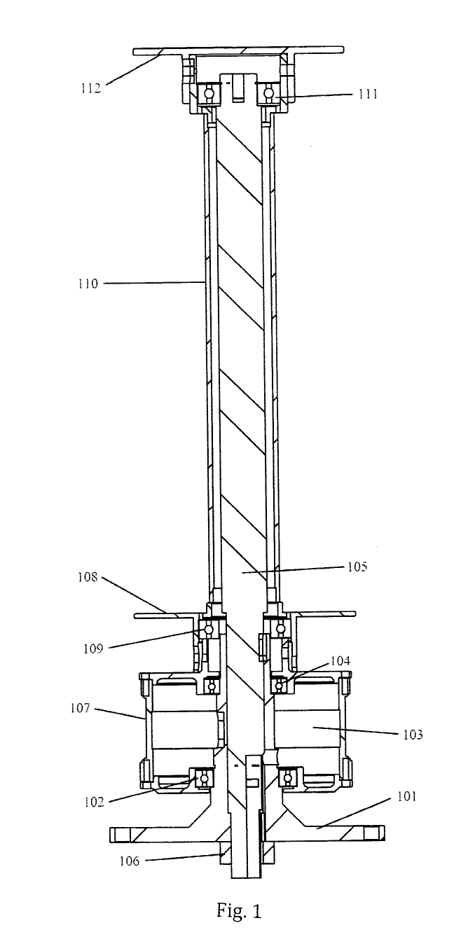

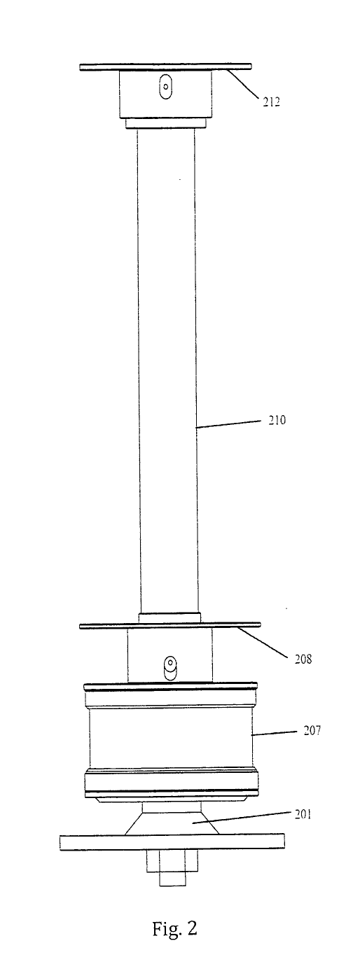

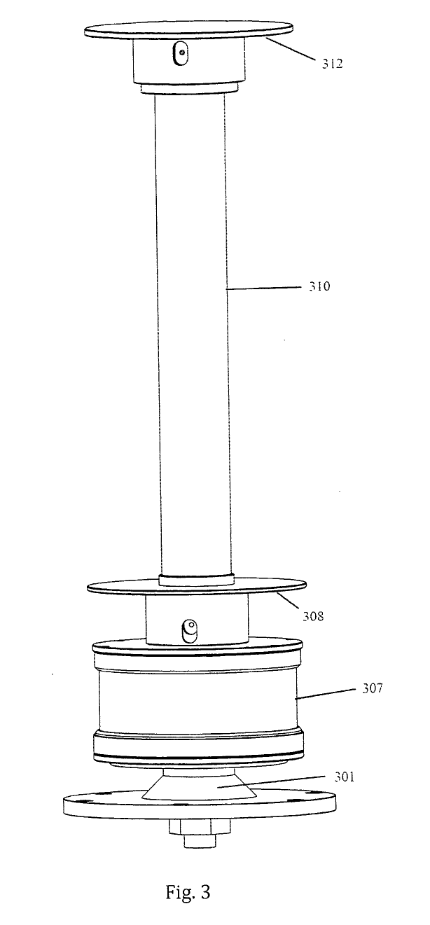

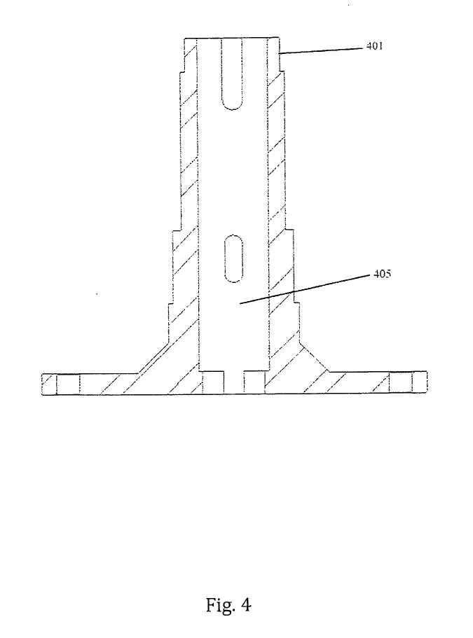

According to FIG. 1, FIG. 2, FIG. 3 and FIG. 4, the generator shaft 101, 201, 301, 401 is a hollow shaft (refer to FIG. 4) and the stator 103 is sheathed on and kept in locational fit with the generator shaft 101, 201, 301, 401. The wind rotor shaft 105, 405 is inserted into the generator shaft 101, 201, 301, 401 and kept in locational fit with the generator shaft 101, 201, 301, 401, and is locked by locknut 106 of the wind rotor shaft 105, 405 at the bottom.

The external rotor 107, 207 307 of the generator is connected with the generator shaft 101, 201, 301, 401 through the generator upper bearing 104 and lower bearing 102. The wind rotor shaft is arranged on the upper flange 112 and lower flange 108 of the wind rotor. Being sheathed on the wind rotor shaft 105 405 the upper bearing 111 and lower bearing 109 of the wind rotor are arranged on the internal of the upper flange 112 and lower flange 108 of the wind rotor, wherein, the lower flange 108 of the wind rotor is connected with the generator external rotor 107 by bolt(s) or attachment means, and the upper flange 112 and lower flange 108 of the wind rotor are connected together through the drive shaft barrel 110 of the wind rotor. With the drive of the wind, the wind rotor brings the drive shaft barrel 110 of the wind rotor to revolve around the wind rotor shaft 105, and generate power by making the generator rotor revolve. It is not necessary to erect the wind rotor shaft 105 during transportation, fabrication or manufacturing, which provides convenience to the generator assembly.

The present invention may provide two shafts for the wind turbine, i.e. the wind rotor shaft 105, 405 and the generator shaft 101, 201, 301, 401, wherein, the generator shaft 101, 201, 301, 401 may be a hollow shaft, and may have the wind rotor shaft 105, 405 inserted into it. Said wind rotor shaft 105, 405 being locked at the bottom. The upper and lower connection arms or airfoils of the wind rotor may be connected with flanges 112, 212, 312, 108, 208, 308 on the wind rotor shaft 105, 405 by bearings 111, 109 or other fixture type, and be united together through the drive shaft barrel 110, 210, 310 of the wind rotor. The wind rotor may be connected with the external rotor 107, 207, 307 of the external rotor generator by bolt(s) or other fixture means, so that the weight may be transferred to tower through the wind rotor shaft 105, 405 to prevent the bearing(s) of the generator being stressed due to the wind rotor being pressed on generator directly, and decrease the start up speed of wind rotor. Meanwhile, the fabrication of the generator would be more convenient due to the dismountability of wind rotor shaft.

The output data for the 4 kW generator shown in Table 1, was produced by attaching a pulley to the 4 kW generator and to a volt reader. The power outputs were recorded using a 75 Ohm load.

TABLE 1
Data table for the power out put of the 4 kW vertical axis
wind turbine model of the present invention.

| Wind | | | | Theoretical |
|---|---|---|---|---|
| Speed(m/s) | DCV | DCA | Power(w) | Output Power |
| 5.5 | 190 | 2.5 | 475 | 366.025 |
| 5.7 | 195 | 2.6 | 507 | 407.4246 |
| 3.7 | 150 | 2 | 300 | 111.4366 |
| 4 | 140 | 1.5 | 210 | 140.8 |
| 5.3 | 150 | 2.2 | 330 | 327.5294 |
| 5.9 | 170 | 2.2 | 374 | 451.8338 |
| 6.9 | 210 | 3.3 | 693 | 722.7198 |
| 4.5 | 165 | 2 | 330 | 200.475 |
| 5.2 | 180 | 2 | 360 | 309.3376 |
| 5.2 | 200 | 2 | 400 | 309.3376 |
| 4.7 | 165 | 1.9 | 313.5 | 228.4106 |
| 5.3 | 200 | 2 | 400 | 327.5294 |
| 4.2 | 160 | 1.2 | 192 | 162.9936 |
| 4.8 | 170 | 1.2 | 204 | 243.3024 |
| 4.9 | 190 | 1.2 | 228 | 258.8278 |
| 6.7 | 250 | 2 | 500 | 661.6786 |
| 5.8 | 220 | 2 | 440 | 429.2464 |
| 6.4 | 230 | 2.4 | 552 | 576.7168 |
| 5.1 | 195 | 1.5 | 292.5 | 291.8322 |
| 5 | 185 | 1.3 | 240.5 | 275 |
| 6.2 | 225 | 1.6 | 360 | 524.3216 |
| 6.6 | 256 | 5 | 1280 | 632.4912 |
| 5.7 | 170 | 2 | 340 | 407.4246 |
| 5 | 150 | 1.8 | 270 | 275 |
| 3.8 | 120 | 1.5 | 180 | 120.7184 |
| 4.2 | 100 | 1.6 | 160 | 162.9936 |
| 5 | 150 | 2 | 300 | 275 |
| 6.7 | 180 | 2 | 360 | 661.6786 |
| 7.3 | 220 | 2.2 | 484 | 855.8374 |
| 5.8 | 210 | 2 | 420 | 429.2464 |
| 8.8 | 263 | 5.5 | 1446.5 | 1499.2384 |
| 8.6 | 254 | 5.5 | 1397 | 1399.3232 |
| 7.1 | 230 | 3.2 | 736 | 787.4042 |
| 8.4 | 260 | 3.9 | 1014 | 1303.9488 |
| 6.2 | 250 | 3.2 | 800 | 524.3216 |
| 7 | 210 | 4 | 840 | 754.6 |
| 7.2 | 240 | 4 | 960 | 821.1456 |
| 8.2 | 220 | 4 | 880 | 1213.0096 |
| 6.7 | 210 | 2.2 | 462 | 661.6786 |
| 5.8 | 220 | 1.8 | 396 | 429.2464 |
| 8.2 | 250 | 3.5 | 875 | 1213.0096 |
| 7.7 | 180 | 2.1 | 378 | 1004.3726 |
| 8.3 | 190 | 2.2 | 418 | 1257.9314 |
| 5.6 | 210 | 2 | 420 | 386.3552 |
| 7.6 | 240 | 2.6 | 624 | 965.7472 |
| 6.8 | 253 | 2.4 | 607.2 | 691.7504 |
| 5.3 | 210 | 1.8 | 378 | 327.5294 |
| 5.5 | 220 | 1.8 | 396 | 366.025 |
| 5.3 | 210 | 1.5 | 315 | 327.5294 |
| 6 | 230 | 2.5 | 575 | 475.2 |
| 7.2 | 260 | 2.9 | 754 | 821.1456 |
| 8.7 | 267 | 5.4 | 1441.8 | 1448.7066 |
| 10 | 260 | 9 | 2340 | 2200 |
| 8.4 | 247 | 4.9 | 1210.3 | 1303.9488 |
| 12 | | | 0 | 3801.6 |

The present invention may be structurally modified in various forms by those skilled in the art, while its utilities remained unchanged. Therefore, once the modifications belong to the Claims of the present invention and the equivalent technical field, the present invention shall cover all these modifications.

1. An external rotor generator for a vertical axis wind turbine comprising an external rotor of the generator 107, 207, 307 and a wind turbine, wherein said wind turbine is arranged on an external rotor generator and wherein said wind turbine comprises a wind rotor shaft 105 and wind rotor, wherein a upper flange(s) 112 and lower flange(s) 108 of the wind rotor are arranged on both ends of a wind rotor shaft, upper and lower through bearing(s) 111, 109, and the wind rotor is arranged on an upper flange(s)and a lower flange(s) of the wind rotor or wherein a midpoint flange(s) of the wind rotor is arranged on a wind rotor shaft through bearing(s) and a wind rotor is arranged on a midpoint flange(s) of a wind rotor and said external rotor of the generator is connected with a generator shaft 101, 102, 301, 401 through a generator upper bearing 104 and a lower bearing 102.

2. The external rotor generator for a vertical axis wind turbine according to claim 1 wherein an external rotor generator comprises generator shaft, 101, 201, 301, 401, stator 103 and external rotor arranged on external stator.

3. The external rotor generator for a vertical axis wind turbine according to claim 2, wherein a generator shaft is a hollow shaft and a stator is arranged on an external surface of a generator shaft, and keeps locational fit with a generator shaft.

4. The external rotor generator for a vertical axis wind turbine according to claim 3, wherein the wind rotor shaft is arranged on an internal surface of the generator shaft 110 and keeps locational fit with a generator shaft.

5-7. (canceled)

8. The external rotor generator for a vertical axis wind turbine according to claim 1, wherein a lower flange of a wind rotor is positioned on or above an upper external rotor generator.

9. The external rotor generator for a vertical axis wind turbine according to claim 8 wherein, a lower flange of a wind rotor is positioned on or above an upper external rotor generator, and connected with an external rotor of an external rotor generator by bolt.

10. The external rotor generator for a vertical axis wind turbine according to claim 8, wherein a lower flange of a wind rotor is positioned on or above an upper external rotor generator, and connected with an external rotor of an external rotor generator by screw, nail and/or nut.

11. The external rotor generator for a vertical axis wind turbine according to claim 1, wherein a drive shaft barrel of a wind rotor is arranged between an upper flange and lower flange of a wind rotor, and a sleeve of a wind rotor drive shaft barrel is arranged on an exterior surface of a wind rotor shaft.

12. The external rotor generator for a vertical axis wind turbine according to claim 1, wherein a drive shaft barrel of a wind rotor is arranged between a first midpoint flange and a second midpoint flange of a wind rotor, and a sleeve of a wind rotor drive shaft barrel is arranged on an exterior of a wind rotor shaft.

13. The external rotor generator for a vertical axis wind turbine according to claim 1, wherein a wind rotor shaft is arranged on an internal surface of a generator shaft and extends through a generator and is attached to a tower below a generator.

14. The external rotor generator for a vertical axis wind turbine according to claim 1, wherein a wind rotor shaft is arranged on an internal surface of a generator shaft and extends through a generator located at an upper end of a wind rotor shaft and attached to a tower above a generator.

15. The external rotor generator for a vertical axis wind turbine according to claim 1, wherein a wind rotor shaft is arranged on an internal surface of a generator shaft and extends through a generator and is attached to a tower below a generator and is attached to a tower above a wind rotor shaft.
